(19) United States
(12) Patent Application Publication
(10) Pub. No.: US 2016/0009178 A1
(43) Pub. Date: Jan. 14, 2016

(54) DISASSOCIATED ARTICULATING DISPLAY DEVICE FOR A VEHICLE INTERIOR

(71) Applicants: Klaus Busse, Lake Orion, MI (US); Timothy W. Grogan, Rochester Hills, MI (US); Glenn W. Abbott, West Bloomfield, MI (US); Cecile M. Giroux, Auburn Hills, MI (US); Kenneth E. Zalewski, Shelby Township, MI (US)

(72) Inventors: Klaus Busse, Lake Orion, MI (US); Timothy W. Grogan, Rochester Hills, MI (US); Glenn W. Abbott, West Bloomfield, MI (US); Cecile M. Giroux, Auburn Hills, MI (US); Kenneth E. Zalewski, Shelby Township, MI (US)

(21) Appl. No.: 14/330,432

(22) Filed: Jul. 14, 2014

(51) Int. Cl. B60K 37/02

(52) U.S. Cl. CPC B60K 37/02

(57) ABSTRACT

A display system for a vehicle includes a display device, a pivot coupling and an electronically controlled locking arrangement. The display device includes a screen and a housing. The pivot coupling is configured to, in an exemplary implementation, pivotably fix the display device to an instrument panel of the vehicle such that the display device is non-removably spaced apart from the instrument panel and articulatable relative thereto. The electronically controlled locking arrangement is, in an exemplary implementation, associated with the pivot coupling and display device and is configured to i) be selectively activated to lock the pivot coupling to lock a position of the display device relative to the instrument panel, and ii) be selectively deactivated to unlock the pivot coupling to allow for articulation of the display device relative to the instrument panel.

### FIELD

The present disclosure relates generally to a display device for a vehicle interior and, more particularly, to a disassociated articulatable display device for a vehicle interior.

### BACKGROUND

Modern automotive vehicles often include a radio unit having a display screen built into the dash or instrument panel in a recessed manner for various audio and/or entertainment system functions. Some vehicles also associate control of other vehicle functions, such as climate control, with these display screens. As more vehicle control functions are associated with such display screens, their use by vehicle occupants (e.g., driver and front seat passenger) is increasing. These conventional display screens, however, are typically not positioned in an optimal orientation for viewing and use by drivers of different anatomical sizes. Moreover, such display screens are not adjustable to change their orientation. For example, these display screens are not adjustable to both an orientation focused on the driver and an orientation focused on a front seat passenger. Thus, while conventional vehicle display screens work for their intended purpose, there remains a need for improvement in the relevant art.

### SUMMARY

In one aspect, a display system for a vehicle is provided in accordance with the teachings of the present disclosure. In an exemplary implementation, the display system includes a display device, a pivot coupling and an electronically controlled locking arrangement. The display device includes a screen and a housing. The pivot coupling is adapted to, in an exemplary implementation, pivotably fix the display device to an instrument panel of the vehicle such that the display device is non-removably spaced apart from the instrument panel and articulatable relative thereto. The electronically controlled locking arrangement is, in an exemplary implementation, associated with the pivot coupling and display device and is configured to i) be selectively activated to lock the pivot coupling to lock a position of the display device relative to the instrument panel, and ii) be selectively deactivated to unlock the pivot coupling to allow for articulation of the display device relative to the instrument panel.

In some implementations, the pivot coupling comprises a ball and socket coupling, which includes a ball member coupled to one of the display device and the instrument panel and a socket member coupled to the other of the display device and the instrument panel.

In some implementations the electronically controlled locking arrangement comprises an electromechanical locking arrangement including an electromagnet associated with the socket member and a ferrous member or portion associated with the ball member, where the ferrous member is in selective movable engagement with the electromagnet. In some implementations, upon activation of the electronically controlled locking arrangement, the electromagnet is activated to lock a position of the ball member relative thereto, which locks movement of the display device.

In some implementations, the display device includes an actuator in communication with the electronically controlled locking arrangement. The actuator is configured to be actuated to selectively activate and deactivate the electronically controlled locking arrangement. In some implementations, the actuator includes a switch on the display device adapted to receive input from an occupant of the vehicle. In an exemplary implementation, the switch comprises a plurality of switches, with one of the plurality of switches positioned on a front side of the display device adjacent a perimeter of the display device and another of the plurality of switches positioned on a rear side of the housing facing the instrument panel and inboard of the perimeter. In some implementations, the screen of the display device includes a touch screen and the switch is an icon associated with the touch screen and adapted to receive input in the form of a touch by the occupant of the vehicle.

In some implementations, the display system includes a power cord for the display device that is fed through the pivot coupling so as to be concealed from view. In an exemplary implementation, the display device housing includes a shroud extending therefrom that is configured to house at least a portion of the pivot coupling, locking arrangement and power cord so as to be concealed the same from view.

In another aspect, a vehicle is provided in accordance with the teachings of the present disclosure. In an exemplary implementation, the vehicle includes a display device, a pivot coupling, an electronically controlled locking arrangement and a controller. The display device includes a touch screen and a housing. The pivot coupling is configured to, in an exemplary implementation, pivotably fix the display device to an instrument panel of the vehicle such that the display device is non-removably spaced apart from the instrument panel and selectively articulatable relative thereto. The electronically controlled locking arrangement is associated with the pivot coupling and display device and the controller is in communication with the display device, the electronically controlled locking arrangement and an ignition system of the vehicle. In an exemplary implementation, the controller is configured to i) selectively activate the locking arrangement to lock the pivot coupling to lock a position of the display device relative to the instrument panel based on a signal from the ignition system, and ii) selectively deactivate the locking arrangement to unlock the pivot coupling to allow for articulation of the display device relative to the instrument panel based on a signal from an actuator associated with the display device.

In some implementations, the actuator includes a switch positioned on the display device and adapted to be activated by input from a vehicle occupant. Upon activation of the switch, the electronically controlled locking arrangement is configured to be deactivated for a duration of the switch activation.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a partial perspective view of an exemplary vehicle interior including an exemplary disassociated articulatable display device according to the principles of the present disclosure;

FIG. 2 is an enlarged partial perspective view of the vehicle interior and disassociated articulatable display device of FIG. 1 according to the principles of the present disclosure;

FIG. 3 is a perspective view of the disassociated articulatable display device including an exemplary illustration of a driver manipulating an orientation of the device according to the principles of the present disclosure;

FIG. 4 is a rear perspective view of the disassociated articulatable display device and a partial view of the vehicle interior according to the principles of the present disclosure;

FIG. 5 is a rear view of the disassociated articulatable display device according to the principles of the present disclosure;

FIG. 6 is a side view in partial section of the disassociated articulatable display device and an associated coupling arrangement according to the principles of the present disclosure;

FIG. 7 is partial perspective view of a coupling arrangement associated with the disassociated articulatable display device according to the principles of the present disclosure; and

FIG. 8 is an example functional block diagram of a vehicle having a disassociated articulatable display device according to the principles of the present disclosure.

### DESCRIPTION

With initial reference to FIG. 1, an exemplary vehicle is schematically shown and generally identified at reference numeral 10. In the exemplary implementation illustrated, the vehicle 10 includes an exemplary dash or instrument panel 14 having an exemplary disassociated articulatable display device 18. In the example illustrated, the instrument panel 14 is located adjacent to and/or under a windshield 22 in an interior 26 of vehicle 10. A center console 30 is positioned between a driver's seat 34 and a passenger seat 38 and extends to and/or is integrated with the instrument panel 14.

As will be discussed in greater detail below, the disassociated articulatable display device 18, in accordance with various aspects of the present disclosure, is pivotably fixed to the vehicle in spaced relation to an exterior surface of the instrument panel 14 and is selectively articulatable and lockable in various orientations relative thereto. Advantageously, the display device 18 is therefore selectively positionable and lockable in various orientations for optimal use and/or viewing to one or both of a driver and a front seat passenger. In one exemplary implementation, the disassociated articulatable display device is non-removably fixed to the instrument panel through a pivotable coupling for theft mitigation purposes.

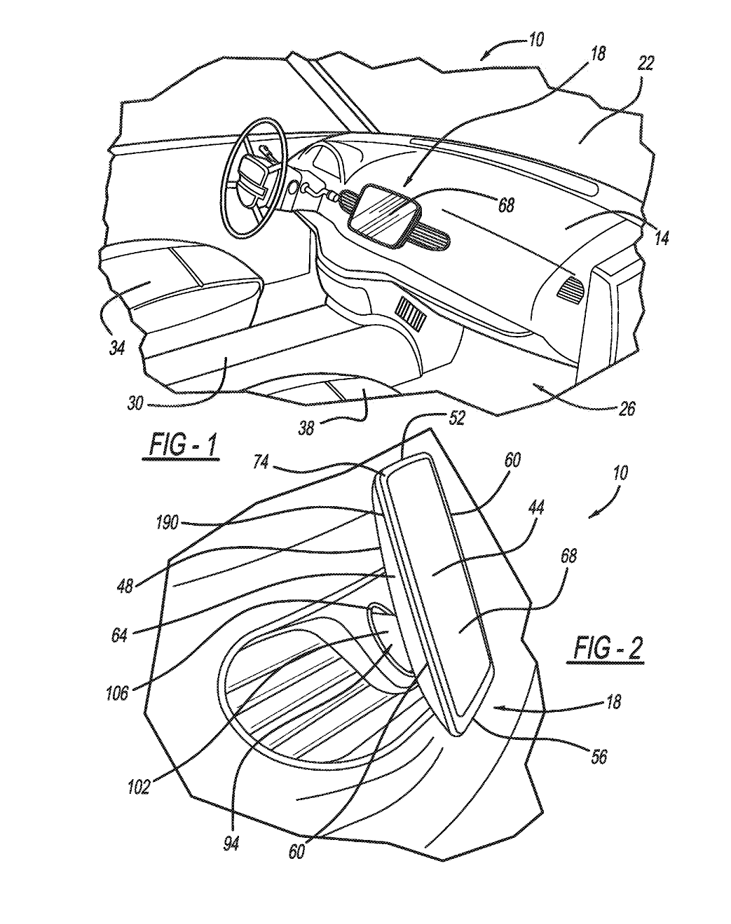

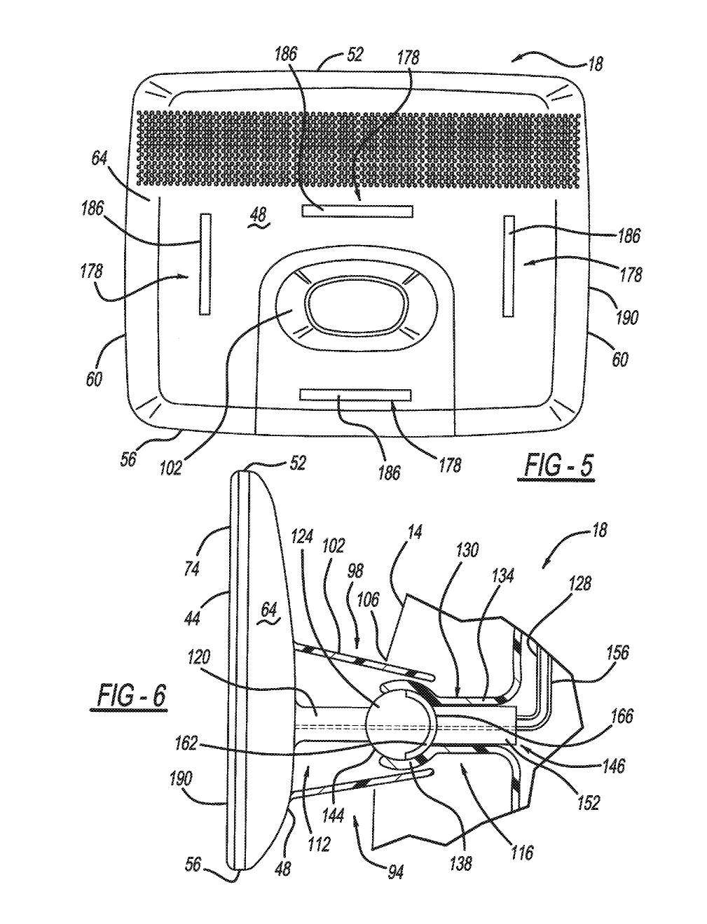

With continuing reference to FIG. 1 and additional reference to FIGS. 2-7, the disassociated articulatable display device 18 will now be discussed in greater detail. The display device 18 includes a front or viewing side 44, an opposed rear side 48, an upper or top side 52, a lower or bottom side 56, and opposed lateral sides 60. The display device 18 also includes a housing 64 and a screen 68, such as a touch screen. In one exemplary implementation, the housing 64 forms the rear side 48, top, bottom and lateral sides 52, 56, 60 and forms a frame portion 74 around screen 68. In an exemplary implementation, frame portion 74 includes a minimal thickness so as to provide the visual effect of a frameless appearance of the screen 68 of display device 18. The display device 18 also includes, in the exemplary implementation illustrated, a minimal thickness from a front side to a rear side, as shown in the various Figures.

In accordance with various aspects of the present disclosure, the display device 18 can be a stand-alone device having the touch screen 68 and a control unit 78 (FIG. 8) having one or more processors or microprocessors, memory, a communication module or system for communicating with various vehicle systems and/or controller, and a power input for receiving power from the vehicle's power system. In accordance with various aspects of the present disclosure, the display device 18 can also be merely a display unit having touch screen 68 and configured to receive input from user interaction with touch screen 68 and/or from other vehicle systems in communication with display device 18.

The display device 18 can display various different types of information via a display associated with screen 68, as will be readily appreciated by those skilled in the art. Examples include, but are not limited to navigational information, climate control information, audio settings, trip information, connectivity information regarding one or more paired mobile devices, vehicle information, and the like. Additionally, and subject to adequate safety precautions, the display device 18 can also display entertainment, such as movies through a digital video disc (DVD), wireless information or the like, and Internet access. The display device 18 can also include navigation capability, such as a GPS navigation system operable to plan trips, locate destinations, provide directions and the like.

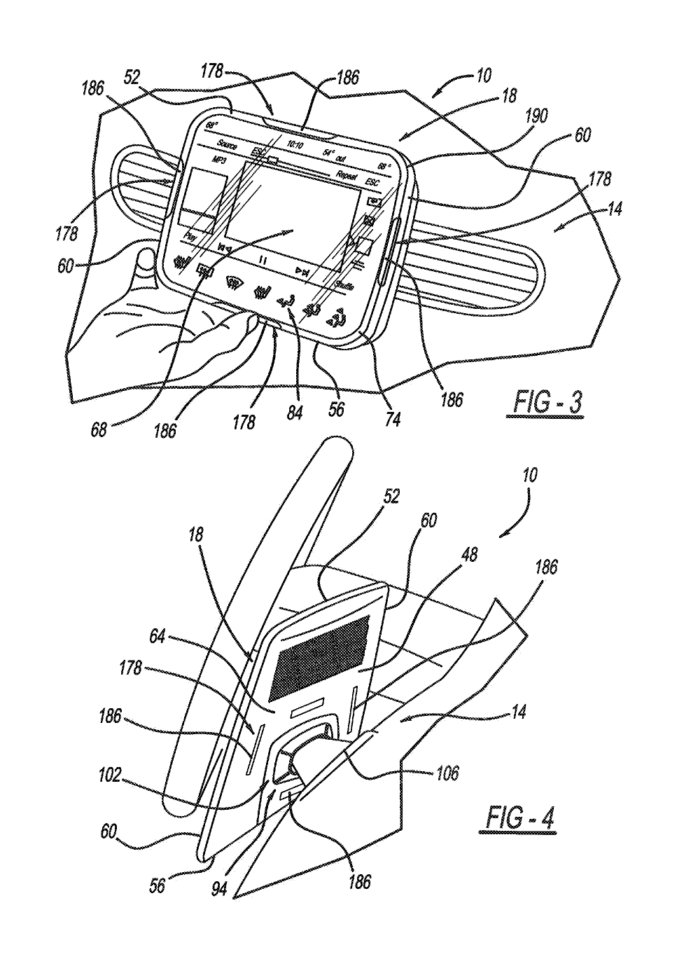

In one exemplary implementation, the touch screen 68 of display device 18 includes a touch panel and a display. In this exemplary implementation, the touch panel is a component of the touch screen 68, which is sensitive to a touch or contact to a surface of the touch screen 68. The touch panel may be a touch sensitive layer arranged as an upper surface of the display of device 18, or may be intergrated in the display. In other words, the touch panel can be a component implementing a touch sensing technique. Examples include a resistive touch screen panel, a capacitive touch screen panel, and an optical touch screen. Such touch screens are capable of resolving the position of a single touch (e.g., resistive touch screen panel) or multiple simultaneous touches (e.g., capacitive touch screen panel). Such touches may be associated with various icons 84 (FIG. 3) displayed by the display of device 18. In response to a touch, such as relative to one of the icons 84, touch screen 68 delivers a corresponding signal or position information to control unit 78 of display device 18.

As briefly mentioned above, the display device 18, in the exemplary implementation illustrated, is pivotably fixed to the instrument panel 14 via a coupling arrangement 94. In one exemplary implementation, the display device 18 is pivotably fixed to the instrument panel 14 at a central location from a lateral or cross-car perspective. In an exemplary implementation, this location is aligned with the center console 30 and provides access to both the driver and the front seat passenger. It will be appreciated, however, that the display device 18 can also be pivotably fixed at other interior locations, such as on an upper area or portion of center console 30.

With particular reference to FIGS. 2 and 4-7, the exemplary coupling arrangement 94 will now be discussed. The coupling arrangement 94, in the exemplary implementation illustrated, pivotably fixes the display device 18 to the instrument panel 14 such that the display device is positioned in spaced relation to the instrument panel 14. In accordance with an aspect of the present disclosure, the coupling arrangement pivotably fixes the display device 18 to the instrument panel 14 in a non-removable or permanent fashion, which is advantageous for theft mitigation purposes.

In the exemplary implementation illustrated, the coupling arrangement 94 includes a pivot coupling arrangement, such as the illustrated ball and socket arrangement 98. In an exemplary implementation, the coupling arrangement 94 is concealed by a shroud 102 extending from housing 64. In one exemplary implementation, the shroud 102 is an integral part of the housing 64 and extends into an opening 106 in the instrument panel 14 so as to conceal the coupling arrangement 94 and any electrical and/or communication wires/cables routed from the instrument panel 14 to the display device 18. In the exemplary implementation illustrated, the shroud 102 includes a substantially cylindrical or conical shape and includes a hollow interior to receive the coupling arrangement 94.

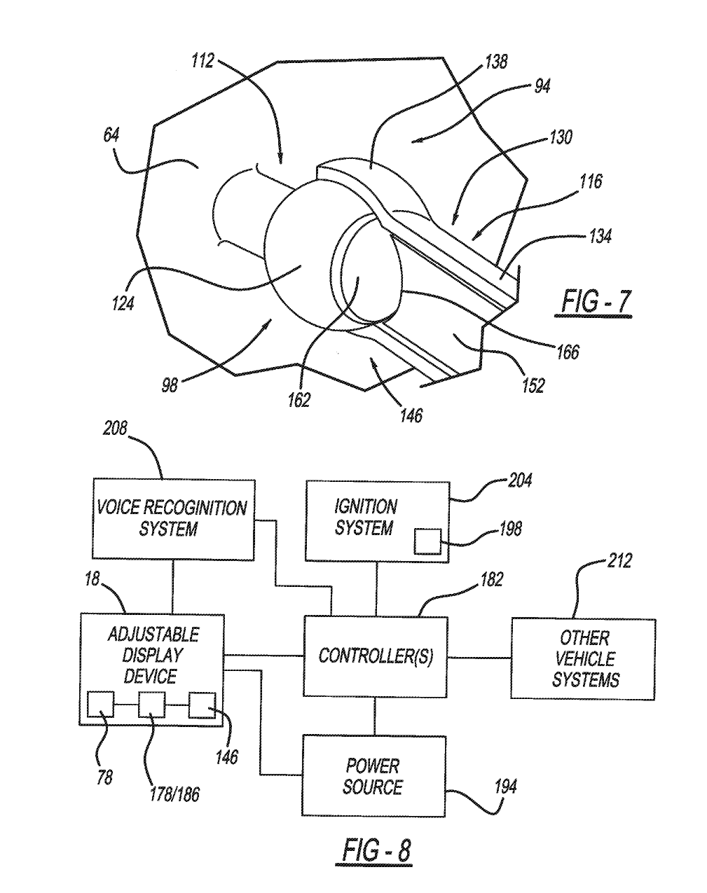

The ball and socket arrangement 98 includes, in one exemplary implementation, a ball coupling arrangement or portion 112 and a socket arrangement or portion 116, as shown for example in FIGS. 6 and 7. In the exemplary implementation illustrated, the ball coupling arrangement 112 includes a stem or shaft 120 and a ball member 124. The stem or shaft 120 can include varying lengths and is fixed to the rear side 48 of the display device 18. In the examples illustrated, the stem 120 includes a length sufficient to space the ball member 124 from the rear side 48 of the display device 18, as shown for example in FIGS. 6 and 7. In one exemplary implementation, one or more electrical, data and/or communication wires or cords 128 are fed through the coupling arrangement 94 and shroud 102 to the display device so as to be hidden from view, as shown for example in FIG. 6.

The socket coupling arrangement 116 includes, in the exemplary implementation illustrated, a body 130 forming a stem or shaft portion 134 and a socket member 138. The stem 134 is fixed to the vehicle 10, such as to or proximate to the instrument panel 14 and/or its supporting structure. The socket member 138 is configured to receive the ball member 124 therein so as to form the pivotable and/or articulatable ball and socket arrangement 98. In one exemplary implementation, the ball member 124 has a spherical outer shape 144 with a diameter sized and shaped together with a complimentary diameter of the socket member 138 so as to provide frictional fit relationship between the ball member 124 and socket member 138.

In this exemplary implementation, the socket member 138 can include partially flexible or resilient characteristics so as to receive the ball member 124 therein and provide frictional resistance to movement of the ball member 124 relative thereto based on a predetermined threshold lever of force input from a user. Such force input threshold may be designed, for example, to provide easy manipulation by a user to various positions while being able to maintain the display device in the desired position without further input from the user to the touch screen.

It will be appreciated that while the discussion will continue with reference to the illustrated example of the socket member 138 being associated with the instrument panel 14 side and the ball member 124 being associated with the display device 18 side, an opposite arrangement is also contemplated by the present disclosure. In other words, in one exemplary implementation, the socket member 138 may be associated with the display device 18 and the ball member 124 may be associated with the instrument panel 14. The ball and socket coupling arrangement provides for almost infinite adjustment of the display device 18 about multiple axes and/or planes to achieve a desired user orientation. For example, the display device 18 could be rotated about the coupling arrangement 94 while maintaining the screen 68 parallel to a desired plane and could also be tilted relative to a longitudinal plane and/or a lateral plane of vehicle 10.

In accordance with various aspects of the present disclosure, the coupling arrangement 94 includes a selectively actuatable locking device or arrangement 146 configured to selectively lock a position of the display device 18 relative to the instrument panel 14. In an exemplary implementation, the locking arrangement includes an electromagnetic locking arrangement configured to be selectively actuated to lock the display device 18 in the desired orientation or position. It will be appreciated that other selectively actuatable locking arrangement or devices could be utilized and are contemplated by the present disclosure.

With particular reference to FIGS. 6 to 8 and continuing reference to FIGS. 1-5, the exemplary electronically controlled locking arrangement 146 will now be discussed. In an exemplary implementation, the locking arrangement 146 is an electromagnetic locking arrangement including an electromagnet 152 positioned or housing in the stem 134 of the socket coupling arrangement 116. One example of such an electromagnet is a coil of wire wrapped around a ferromagnetic core, such as iron, as will be readily appreciated by those skilled in the art. Electric current flowing in the wire wrapping the core produces a magnetic field through a center of the coil, which can be rapidly manipulated by controlling the amount of electric current. The electromagnetic 152 can be coupled to a power or electric current source, such as via a power line or cord 156.

The ball member 124 includes, in the exemplary implementation illustrated, a ferromagnetic cap 162, such as an iron cap, configured to selectively movingly engage or substantially engage an end of the electromagnetic 152. Depending on the orientation of the display device 18 relative to the instrument panel 14, a portion of the cap 162 may be always or sometime in contact with the socket member 138. In one exemplary implementation, the cap 162 includes an arcuate surface so as to conform or substantially conform to or be flush with the spherical shape of the ball member 124. Similarly, in this exemplary implementation, the electromagnet 152 includes a spherically shaped end 166 complimentary to the spherical shape of the cap 162. The cap 162 is sized and shaped so as to have a sufficient portion in contact with the electromagnet 152 in all articulatable positions or orientations of the display device 18.

With particular reference to FIGS. 3 and 5-8, control of the electromagnetic locking arrangement 146 in connection with various control features of the display device 18 and/or vehicle 10 will now be discussed. As briefly mentioned above, the ball and socket coupling arrangement 98 provides, in one exemplary implementation, mechanical frictional resistance to movement of the display device 18 so as to provide a desirable feel to a user when manipulating the display device 18 to a desired orientation. In this regard, one example of the mechanical frictional resistance used to provide such a desirable feel may include enough resistance to hold the display device 18 in a desired position without any input from the user to the touch screen 68 or other portions of the display device 18. In other words, to provide the desirable feel and minimal resistance to movement of the display device 18 for reorientation purposes, the display device 18 may be inadvertently moved from a desired orientation when a user engages the touch screen 68 (and the locking arrangement is not actuated).

As a result, the locking arrangement 146 is configured to be controlled to be selectively actuated and deactivated based on various operating conditions of the vehicle and/or user input, as will be discussed in greater detail below. In this regard, the display device 18 includes, in one exemplary implementation, a plurality of actuators 178 are positioned on the display device 18 in various locations for selective actuation by a user. The actuators 178 along with the display device 18 (such as via the control unit 78) are in communication with one or more controllers and/or control modules 182 of the vehicle 10 directly and/or indirectly, such as through a controller area network.

The actuators 178 can be, in one exemplary implementation, any switch arrangement, including an icon 84 associated with the touch screen 68, configured to receive input from the user. In one exemplary implementation, the actuators 178 are switches 186 positioned around a perimeter 190 of the display device 18 so as to be readily accessible by a thumb or finger of the user, as shown for example in FIG. 3. In one exemplary implementation, the switches are positioned along the top, bottom and lateral sides 52, 56 and 60, as also shown in FIG. 3. As will be discussed in greater detail below in connection with operation of the display device 18 and locking arrangement 146, the switches 186 can be electric or electromechanical switches and can be utilized by an occupant of vehicle 10 to selectively deactivate and activate the locking arrangement 146.

In accordance with various aspects of the present disclosure, the actuators 178 can be positioned on one or more of the front side 44, the front side/perimeter 190, and the rear side 48. In the exemplary implementation illustrated, the actuators 178 are positioned on both the front side/perimeter 44/190 and the rear side 48, as shown for example in FIGS. 3 to 5. In this exemplary implementation, the front actuators 178 can be in the form of switches 186 or touch screen icons and can be positioned along or adjacent the perimeter 190 so as to be actuated by a thumb of a user when grasping the display device 18, as shown in FIG. 3. The rear actuators 178 can also be in the form of switches 186 and can be positioned inboard of the perimeter 190 so as to be actuated by one or more fingers of the user when grasping the display device in the manner shown for example in FIG. 3. In the example illustrated, the rear actuators 178 include four switches 186 positioned inboard of the perimeter 190 while otherwise being generally aligned with the corresponding front/perimeter switches 186.

With particular reference to FIG. 8 and continuing reference to FIGS. 1-7, the locking arrangement 146 and actuators 178 are in communication with the control unit of the display device 18, which is in communication with the controller 182. The controller 182 is also in communication with a power source 194 of the vehicle 10, such as one or more batteries, an ignition key position sensor 198 of an ignition system 204 of vehicle 10, a voice recognition system 208, and one or more other vehicle systems 212 discussed above and associated with and/or in communication with the display device 18. The voice recognition system 208 is configured to be activated by a user in a known manner to receive one or more voice commands for controlling one or more associated systems, such as the display device 18 and associated locking arrangement 146. In this regard, the discussion of actuators 178 herein includes the voice recognition system 208 being utilized to control (e.g., activate and deactivate) the locking arrangement 146. Examples of such other systems 212 include, but are not limited to the navigation system, the climate control system, the entertainment system, a memory seat system and a radio system.

In operation and as briefly discussed above, the display device 18 is configured to be selectively locked in a current and/or desired position based on certain predetermined vehicle operating conditions and/or user input via actuators 178. For example, the controller(s) 182 could be configured to activate the locking arrangement 146 to lock the coupling arrangement 94 and thereby lock the display device 18 in the then current orientation based on input from the ignition system 204 that the vehicle power source (e.g., engine) has been turned on and/or input from the ignition key position sensor 198 indicating the key (manual key or keyless go pushbutton system) has been turned to an accessory position or beyond to a run position. In this example, the controller 182 is configured to maintain the locking arrangement 146 in the locked state until the vehicle 10 is turned off and/or other input is received, as discussed in greater detail below.

As discussed above, the locking arrangement 146 is configured to be deactivated or switched off to allow repositioning or reorientation of the display device 18. In one exemplary implementation, the locking arrangement 146 is switched off or deactivated by a user interacting with the actuators 178 in the form of switches 186 upon touching or grasping the display device 18. Once the locking arrangement 146 is deactivated, the display device 18 is articulatable to a desired position. The locking arrangement 146 is then reactivated or activated to lock the display device 18 in the new or current position. The locking arrangement 146 is configured to be activated or reactivated in based on one or more inputs in accordance with various aspects of the present disclosure.

For example, in one exemplary aspect, the locking arrangement 146 is activated in the manner discussed above and is deactivated upon touching or depressing one of the switches 186 and remains deactivated only for as long as the switch 186 is depressed or activated. Once the user no longer interacts with the switch 186, such as by removing the user's hand from the switch 186, the locking arrangement 146 is automatically reactivated to lock the display device 18 in the then current position. In another exemplary aspect, the user touches or interacts with one of the switches 186 to deactivate the locking arrangement 146 and then repositions or orientates the display device 18 to a desired position. The user then, upon orientating the display device 18 in the desired position, again touches one of the switches 186 to reactivate the locking arrangement 146. In yet another exemplary implementation, a user utilizes the voice recognition system 208 and a predetermined voice command, such as “Unlock Display”, to deactivate the locking arrangement 146. Upon manipulating the display device 18 to a desired position, the user then utilizes the voice recognition system 208 and a predetermined voice command, such as “Lock Display”, to activate the locking arrangement 146.

The associated pivot coupling 94 and electronically controlled locking arrangement 146 thus provide for a disassociated display device 18 that is positioned in spaced relation to and selectively articulatable relative to an adjacent instrument panel 14 or the like. The display device 18 is articulatable relative to the instrument panel 14 through use of coupling arrangement 94 that provides mechanical friction or resistance to movement of the display device 18 up to a predetermined force threshold so as to provide a desirable feel to a user. The mechanical friction, in one exemplary implementation, can be easily overcome by common force applied to the display device 18 by an operator of the vehicle. As a result, the display device includes the selectively actuatable locking arrangement 146 configured to be controlled to selectively lock the display device 18 in its current position. In one example implementation, the locking arrangement 146 is configured to be deactivated and reactivated in connection with common user input associated with manipulating a position of the display device 18, such as in connection with grasping the display device 18.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A display system for a vehicle, the display system comprising:
a display device including a screen and a housing;
a pivot coupling adapted to pivotably fix the display device to an instrument panel of the vehicle such that the display device is non-removably spaced apart from the instrument panel and articulatable relative thereto; and
an electronically controlled locking arrangement associated with the pivot coupling and display device, the locking arrangement configured to i) be selectively activated to lock the pivot coupling to lock a position of the display device relative to the instrument panel, and ii) be selectively deactivated to unlock the pivot coupling to allow for articulation of the display device relative to the instrument panel.

2. The display system of claim 1, wherein the pivot coupling comprises a ball and socket coupling, the ball and socket coupling including a ball member coupled to one of the display device and the instrument panel and a socket member coupled to the other of the display device and the instrument panel.

3. The display system of claim 2, wherein the electronically controlled locking arrangement comprises an electromechanical locking arrangement including an electromagnet associated with the socket member and a ferrous member or portion associated with the ball member, the ferrous member in selective movable engagement with the electromagnet.

4. The display system of claim 3, wherein upon activation of the electronically controlled locking arrangement, the electromagnet is activated to lock a position of the ball member relative thereto, thereby locking movement of the display device.

5. The display system of claim 1, further comprising an actuator associated with the display device, the actuator in communication with the electronically controlled locking arrangement and configured to be actuated to selectively activate and deactivate the electronically controlled locking arrangement.

6. The display system of claim 5, wherein the actuator includes a switch on the display device adapted to receive input from an occupant of the vehicle.

7. The display system of claim 6, wherein the switch comprises a plurality of switches, one of the plurality of switches positioned on a front side of the display device adjacent a perimeter of the display device, and another of the plurality of switches positioned on a rear side of the housing facing the instrument panel and inboard of the perimeter.

8. The display system of claim 6, wherein the screen of the display device includes a touch screen, and wherein the switch is an icon associated with the touch screen and adapted to receive input in the form of a touch by the occupant of the vehicle.

9. The display system of claim 2, wherein the ball and socket coupling is configured to provide frictional resistance to articulation of the display device relative to the instrument panel, the frictional resistance configured to i) hold the display device in a current position in an absence of input from a user to the screen of the device, and ii) be overcome by input from the user to the display device or the screen to facilitate articulation of the display device relative to the instrument panel.

10. The display system of claim 1, further comprising a power cord for the display device, the power cord fed through the pivot coupling so as to be concealed from view.

11. The display system of claim 10, wherein the housing further comprises a shroud extending therefrom and configured to house at least a portion of the pivot coupling, locking arrangement and power cord so as to be concealed from view.

12. The display system of claim 1, further comprising a controller in communication with the display device, the electronically controlled locking arrangement, and a vehicle ignition system;
wherein the controller is configured to selectively activate the electronically controlled locking arrangement upon receiving a signal from the vehicle ignition system indicative of the ignition system being placed in an accessory or run position; and
wherein the controller is configured to selectively deactivate the electronically controlled locking arrangement upon receipt of a signal from a switch associated with the electronically controlled locking arrangement indicative of actuation of the switch.

13. A vehicle, comprising:
a display device including a touch screen and a housing;
a pivot coupling pivotably fixing the display device to an instrument panel of the vehicle such that the display device is non-removably spaced apart from the instrument panel and selectively articulatable relative thereto;
an electronically controlled locking arrangement associated with the pivot coupling and display device; and
a controller in communication with the display device, the electronically controlled locking arrangement and an ignition system of the vehicle;
wherein the controller is configured to i) selectively activate the locking arrangement to lock the pivot coupling to lock a position of the display device relative to the instrument panel based on a signal from the ignition system, and ii) selectively deactivate the locking arrangement to unlock the pivot coupling to allow for articulation of the display device relative to the instrument panel based on a signal from an actuator associated with the display device.

14. The vehicle of claim 13, wherein the actuator includes a switch positioned on the display device and adapted to be activated by input from a vehicle occupant, and wherein upon activation of the switch, the electronically controlled locking arrangement is configured to be deactivated for a duration of the switch activation.

15. The vehicle of claim 13, wherein the pivot coupling comprises a ball and socket coupling having a ball member coupled to one of the display device and the instrument panel and a socket member coupled to the other of the display device and the instrument panel.

16. The vehicle of claim 15, wherein the electronically controlled locking arrangement comprises an electromechanical locking arrangement including an electromagnet associated with the socket member and a ferrous member or portion associated with the ball member, the ferrous member in selective movable engagement with the electromagnet; and
wherein upon activation of the locking arrangement, the electromagnet is activated to lock a position of the ball member relative thereto, thereby locking movement of the display device.

17. The vehicle of claim 15, further comprising a power cord for the display device, the power cord fed through the pivot coupling so as to be concealed from view.
